(19) United States
(12) Patent Application Publication
(10) Pub. No.: US 2012/0166003 A1
(43) Pub. Date: Jun. 28, 2012

(54) System for Evaluating, Measuring and Verifying Power Consumption Based on Price-Point Control

(76) Inventor: James Eric Taylor, El Centro, CA (US)

(21) Appl. No.: 12/977,524

(22) Filed: Dec. 23, 2010

(51) Int. Cl. G06F 1/26

(52) U.S. Cl. 700/291

(57) ABSTRACT

A system and method for evaluating, measuring and verifying energy consumption at a facility requires initially establishing a benchmark at the facility based on price-point variations for energy costs, set by the regional ISO. The benchmark is established by measuring the facility's Energy Consumption Level (ECL) over a 30-day period, while no conservation efforts are being taken. To obtain an incentive award, a target value Energy Saving Factor (ESF) is identified relative to the benchmark. Energy conservation efforts are then implemented to control the ECL of the facility in response to price-point variations. When the target value ESF is maintained for a predetermined time, an incentive award is warranted and, once verified, can be given immediately.

### FIELD OF THE INVENTION

The present invention pertains generally to systems and methods for controlling the consumption of electrical energy at a facility. More particularly, the present invention pertains to systems and methods for determining when energy consumption levels are sufficiently low to warrant the issuance of an incentive award. The present invention is particularly, but not exclusively, useful as a system and method for evaluating, measuring and verifying the energy consumption at a facility, in real-time, for the purpose of recognizing energy conservation efforts in a timely manner.

### BACKGROUND OF THE INVENTION

Efforts to conserve energy have rightfully become of paramount interest to many. On a broad scale, these efforts have been directed to almost every aspect of daily life. At the macro-level, this includes transportation, construction, manufacturing and food production activities. At the micro-level, conservation concerns include consumer-control over the heating, air conditioning and general operation of the many different household systems and appliances that are considered essential for our way-of-life. At both levels, energy consumption can be horrendous, with consequent opportunities for conservation. It is apparent, however, that there is no panacea for energy conservation. Nevertheless, it is widely recognized that meaningful efforts for energy conservation at the micro-level are best taken on an ad hoc basis.

At the micro-level, a realistic target for controlling energy consumption is what shall hereinafter be referred to as a facility. In general, a facility can be any defined space or environment where a plurality of operational devices collectively consume energy. In this context, a defined environment can be any area, structure or group of structures (e.g. buildings, homes, factories) having energy requirements for its overall operation. Further, operational devices within a facility can be any type of electrical appliance or motor that is presently known. Within this context, in order to determine the effectiveness of conservation efforts, the total Energy Consumption Level (ECL) of all operational devices at a facility must first be somehow measured. An efficient device for this purpose is the G-Meter manufactured by Enalasys Corporation. Further, the measured ECL must then be somehow controlled. For example, U.S. application Ser. No. 12/908,721 for an invention entitled Interactive System for Price-Point Control of Power Consumption, which is assigned to the same assignee as the present invention, provides an example for computer control over ECL.

Despite the ability to both measure and control energy consumption, there is still a need to incentivize the energy consumer. Obviously, the best incentive here is to provide for a direct pay back of incentive awards, or to implement rate reductions. To do so, however, typical incentive programs require the completion and satisfaction of several disparate requirements. In detail, these are Evaluating, Measuring and Verifying (EM&V) the energy savings at a facility. Importantly, to be really effective, EM&V should all be done in real time.

In light of the above, an object of the present invention is to provide a system and method for evaluating, measuring and verifying energy consumption at a facility which can be accomplished in real-time. Another object of the present invention is to provide a system and method for evaluating, measuring and verifying energy consumption at a facility that is predicated on the energy price-point variations that are continuously provided by government regulated and controlled entities, such as Independent System Operators (ISOs). Still another object of the present invention is to provide a system for evaluating, measuring and verifying energy consumption at a facility that is simple to install, is easy to use and is cost effective.

### SUMMARY OF THE INVENTION

In accordance with the present invention, encouraging energy conservation relies on a system and method for evaluating, measuring and verifying energy consumption at a facility based on data from a plurality of individual operational devices at the facility. Collectively, this data is a measure of the facility's Energy Consumption Level (ECL). In order to establish an operational base line (i.e. benchmark) for the present invention, the ECL of the facility is initially measured and evaluated over a set period of time (e.g. 30 days). Specifically, this is done by operating the facility in a normal manner, without any energy conservation efforts being taken. The objective is then to reduce the operational ECL to a point below the benchmark, for a predetermined period of time that warrants an incentive award.

Evaluation of a facility requires that its operational indicators be identified and quantified. For example, the duty cycles and energy requirements of the various operational devices at the facility are defined. These factors are then considered for their individual and collective contribution to the ECL and establishment of the benchmark (base line) for the facility. Recall, this evaluation is accomplished without any energy conservation efforts. Also, in the evaluation process the devices can be categorized and prioritized according to their need, importance and desirability for the operation of the facility.

Once the benchmark has been established, energy conservation efforts at the facility can then be measured. As envisioned for the present invention, energy conservation efforts at the facility will result from the implementation of a computer controlled program that controls the ECL by selectively shutting down, and selectively turning on, categorized and prioritized operational devices at the facility in accordance with price-point inputs from the regional ISO. Importantly, these efforts are measured as an Energy Saving Factor (ESF) that is, essentially, the difference between the pre-established benchmark and the controlled ECL. Further, the measurements are made over a predetermined time period (e.g. as set forth in an incentive award). Thus, the evaluation is directed toward determining whether a target value for an Energy Saving Factor (ESF) has been achieved, and hopefully exceeded, during the stated time period.

It is an important aspect of the present invention that verification of energy conservation achievements can be made immediately, in real-time. Specifically, after a benchmark has been established, and after a target value for the ESF has been determined that will warrant an incentive award, the actual ECL for the facility can thereafter be controlled, also in real-time. Accordingly, when the target value ESF has been maintained, and hopefully exceeded, for a predetermined time interval, the incentive award can be immediately presented.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an operational schematic for the system and method for the present invention;

FIG. 2 is a function schematic for the system and method for the present invention; and

FIG. 3 is a logic flow chart setting forth a preferred methodology for the present invention.

### DESCRIPTION OF THE PREFERRED EMBODIMENTS

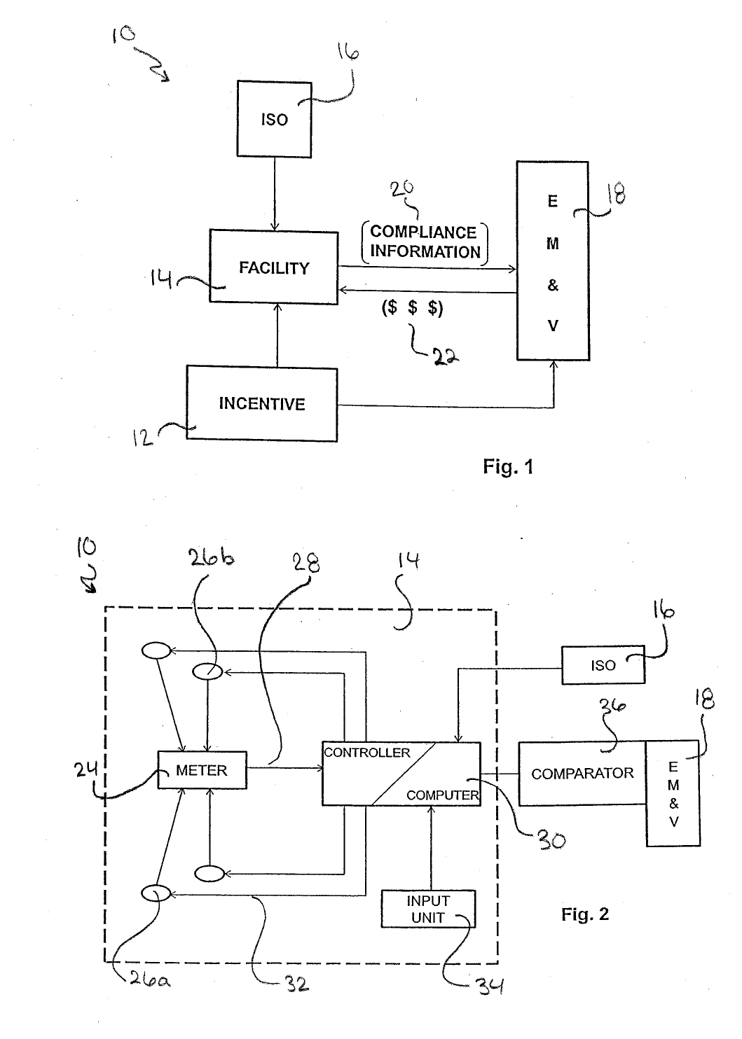

Referring initially to FIG. 1, the operational aspects of a system for implementing an incentive award are shown and generally designated 10. As indicated in FIG. 1, an operation of the system 10 is predicated on the terms of an incentive 12. In particular, this incentive 12 will be uniquely tailored for a facility 14, and it will be specifically directed toward reducing the energy consumption costs at the facility 14. For example, a typical incentive will set a target value for energy consumption costs at the facility 14. Further, the incentive will also typically provide for an award (e.g. money or credits). As envisioned for system 10, this award is immediately payable to the facility 14 whenever the cost for energy at the facility 14 is held at, or below, the target value for a predetermined period of time (e.g. 30 days). In this context, the target value is established to encourage energy conservation efforts at the facility 14, and is based on fixed price-points that are provided by an Independent System Operator (ISO) 16.

Operationally, once an incentive 12 has been defined, the facility 14 can then be evaluated in an operational cycle 18 that involves the Evaluation, Measurement and Verification (EM&V) of its entitlement to a receipt of the incentive award. Stated differently, upon satisfaction of requirements for the incentive 12, in accordance with compliance information 20 from the facility 14, the award (e.g. money 22) can be paid to the facility 14. It is an important aspect of the present invention that, when earned, the incentive award can be paid immediately. This is possible because the energy conservation efforts (i.e. cost reductions) taken by a facility 14 are measured in real-time, using price-point variations from the ISO 16, as they occur.

Turning now to FIG. 2, it is to be appreciated that the facility 14 can be any building, structure, home, factory or combination(s) thereof where energy is consumed. Typically, a facility 14 will be an independent entity that controls electronic devices within the facility 14, and the facility 14 is typically responsible for paying its own electric/power bills. In any case, it is envisioned that the facility 14 will have an on-site meter 24 that is individually connected to each of a plurality of various operational devices 26 at the facility 14. The operational devices 26a and 26b shown in FIG. 2 are only exemplary. Within the facility 14, each operational device 26 will have its own unique energy consuming characteristics, and each will also have its own unique duty cycle. Nevertheless, regardless of the various operational parameters that may individually characterize each operational device 26, the meter 24 is employed at the facility 14 to measure their collective Energy Consumption Level (ECL).

As indicated in FIG. 2, as the ECL of the facility 14 is being measured, the measured information is transferred from the meter 24, via a line 28, to a controller/computer 30. As also indicated in FIG. 2 the controller/computer 30 is connected to each of the operational devices 26. The line 32 between controller/computer 30 and operational device 26a is exemplary. Further to the connection between the ISO 16 and the facility 14 shown in FIG. 1, FIG. 2 shows that the ISO 16 is generally connected directly to the controller/computer 30. As will be appreciated by the skilled artisan, the location of the controller/computer 30 may, or may not, be physically somewhere outside the particular facility 14. In any event, the general connections shown in FIG. 2 are maintained. In addition to the structural connections disclosed above, FIG. 2 also shows that the system 10 includes an input unit 34 and a comparator 36 that are electronically connected to, or are a part of, the controller/computer 30.

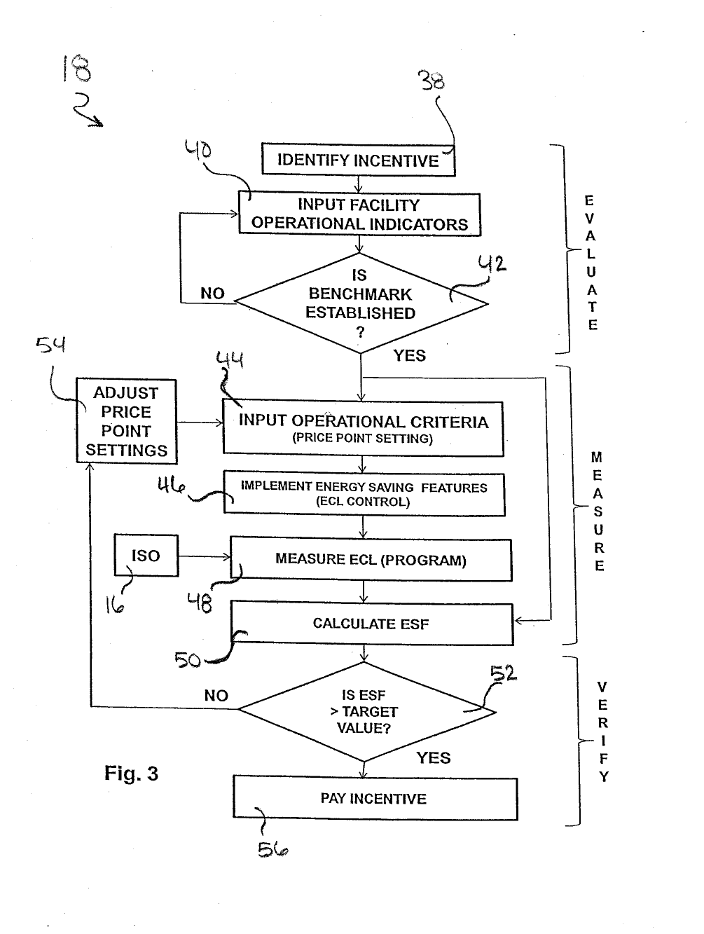

In FIG. 3, a step-by-step presentation for an operation of the system 10 is provided. As shown, action block 38 indicates there must be an incentive 12. Essentially, this involves identifying an acceptable ECL that is based on strategic, energy conservation goals for the facility 14. It also involves establishing time intervals for achieving and maintaining these goals and other pertinent performance objectives. Typically, the incentive 12 will be in the form of a cash payment or operational credits.

For the purpose of implementing the system 10, operational indicators for the facility 14 are programmed into the controller/computer 30 (see action block 40). This involves an evaluation of the collective energy consumption parameters, and duty cycle requirements for each of the operational devices 26 in the facility 14. Typically, this is done by operating the facility 14 over a predetermined period of time (e.g. 30 days) without taking any operational efforts to control energy consumption. All of this information is then averaged over the time period, and is thereby essentially tied to a fixed price-point for energy consumption. Thus, with an understanding of the energy consumption propensities of the operational devices 26, a benchmark (base line) is established. Next, a target value for energy consumption by the facility 14 is established, based on the incentive 12. Importantly, the benchmark is established with the expectation that by achieving energy conservation goals which exceed the target value, an incentive award will be paid to the facility 14.

Inquiry block 42 indicates that once the benchmark has been established, the operation of the system 10 proceeds to actually measure the energy saving efforts of the facility 14. To do this, action blocks 44 and 46 together indicate that the controller/computer 30 is programmed to operate an energy saving regimen that will selectively turn on and shut down operational devices 26 at the facility 14. For this operation, the ECL of facility 14 is controlled (see action block 46) and is measured (see action block 48) against the benchmark to calculate an Energy Saving Factor ESF (see action block 50). Inquiry block 52 then asks whether the ESF is greater than the target value. If not, action block 54 indicates the price-point setting(s) for use by the controller/computer 30 need to be adjusted at the facility 14 for implementation of greater cost savings efforts. On the other hand, when the ESF is greater than the target value, and otherwise satisfies the requirements for the incentive, 12 the award is paid (see action block 56).

While the particular System for Evaluating, Measuring and Verifying Power Consumption Based on Price-Point Control as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for evaluating, measuring and verifying energy consumption at a facility which comprises:
a meter for collectively measuring, in real-time, a respective energy consumption from a plurality of operational devices at the facility to obtain a total Energy Consumption Level (ECL) for the facility;
a computer/controller electronically connected to each operational device in the plurality for selectively shutting down and turning on each operational device to control the ECL in accordance with a predetermined program, wherein the predetermined program is based on price-point settings; and
a comparator for comparing the controlled ECL with a pre-established benchmark to calculate an Energy Saving Factor (ESF) for payment of an incentive award when the ESF is maintained above a given target value for a predetermined time interval.

2. A system as recited in claim 1 further comprising an input unit connected to the computer/controller for selectively adjusting price-point settings of the predetermined program when the ESF is below the target value.

3. A system as recited in claim 1 wherein the benchmark is established by measuring the ECL over a 30-day period without using the predetermined program to selectively shut down and turn on the operational devices at the facility.

4. A system as recited in claim 1 wherein the benchmark and the controlled ECL are based on price-point variations within a respective time duration, and the target value for the ESF is based on a fixed price-point setting.

5. A system as recited in claim 1 wherein the time interval for determining entitlement to the incentive award is approximately 30 days.

6. A system as recited in claim 1 wherein the price-points are provided by a government regulated/controlled entity.

7. A method for Evaluating, Measuring and Verifying (EM&V) energy consumption by a plurality of operational devices at a facility which comprises the steps of:
measuring a total Energy Consumption Level (ECL) for the facility, in real-time, wherein the ECL is based on an input of price-point variations;
establishing a benchmark, wherein the benchmark is based on the ECL of the measuring step over a time period;
controlling the ECL in accordance with a predetermined program;
comparing the controlled ECL of the controlling step with the benchmark to calculate an Energy Saving Factor (ESF);
determining whether the ESF is maintained above a target value for a predetermined time interval, wherein the target value is based on a fixed price-point input; and
awarding the incentive when conditions of the determining step have been satisfied.

8. A method as recited in claim 7 wherein the measuring step is accomplished by collectively obtaining a respective power consumption from a plurality of operational devices at the facility.

9. A method as recited in claim 7 wherein the controlling step is accomplished by shutting down and turning on individual operational devices in accordance with the predetermined program in response to the determining step.

10. A method as recited in claim 9 wherein a shutting down of individual operational devices is accomplished when the ESF is below the target value.

11. A method as recited in claim 7 wherein the establishing step is accomplished over a 30-day period prior to the controlling step.

12. A method as recited in claim 7 wherein the benchmark and the controlled ECL are based on price-point variations within a respective preset time duration.

13. A method as recited in claim 12 wherein the ESF target value is based on a fixed price-point setting.

14. A method as recited in claim 12 wherein each preset time duration is approximately 30 days.

15. A method as recited in claim 7 wherein the predetermined time interval for the determining step is 30 days.

16. A method as recited in claim 7 wherein price-points are provided by a government regulated/controlled entity.

17. A system for Evaluating, Measuring and Verifying (EM&V) energy consumption by a plurality of operational devices at a facility which comprises:
a means for measuring a total Energy Consumption Level (ECL) for the facility, in real-time, wherein the ECL is based on an input of price-point variations;
a means for establishing a benchmark, wherein the benchmark is based on the ECL of the measuring step over a time period;
a means for controlling the ECL in accordance with a predetermined program;
a means for comparing the controlled ECL of the controlling step with the benchmark to calculate an Energy Saving Factor (ESF); and
a means for determining whether the ESF is maintained above a target value for a predetermined time interval, wherein the target value is based on a fixed price-point input.

18. A system as recited in claim 17 wherein the measuring means is a meter.

19. A system as recited in claim 17 wherein the controlling means, the comparing means and the determining means are combined in a computer/controller.

20. A system as recited in claim 17 wherein an incentive award is given when the ESF is maintained above the target value for the predetermined time interval.
